(19) United States
(12) Patent Application Publication
(10) Pub. No.: US 2005/0045204 A1
(43) Pub. Date: Mar. 3, 2005

(54) Cleaning device for a shaving head of a dry shaving apparatus

(76) Inventors: Jurgen Hoser, Neu Anspach (DE); Diana Kappes, Eppstein (DE); Andreas Larscheid, Kelkheim-Fischbach (DE); Uwe Ludascher, Frankfurt (DE); Svatopluk Krumnikl, Kronberg (DE)

Correspondence Address: FISH & RICHARDSON PC, 225 FRANKLIN ST, BOSTON, MA, 02110, US

(21) Appl. No.: 10/935,847

(22) Filed: Sep. 8, 2004

Related U.S. Application Data
(63) Continuation of application No. PCT/EP02/12888, filed on Nov. 18, 2002.

(30) Foreign Application Priority Data
Mar. 8, 2002 (DE) 102 10 349.6

(51) Int. Cl. B08B 3/00

(52) U.S. Cl. 134/13; 134/111; 134/201

(57) ABSTRACT

A cleaning device for a shaving head of a dry shaving apparatus includes a reservoir to store a cleaning fluid, a receptacle adapted to receive the shaving head and the cleaning fluid, the receptacle being configured to direct the cleaning fluid toward the shaving head, a return conduit extending from the receptacle to the reservoir to convey the cleaning fluid from the receptacle into reservoir; and a venting device attached to the reservoir to provide aeration and deaeration of the reservoir.

This invention relates to a cleaning device for a shaving head of a dry shaving apparatus, with a receptacle adapted to receive the shaving head and be impacted by a cleaning fluid, and with a reservoir for storing the cleaning fluid, from which the cleaning fluid is conveyed into the receptacle, from which the cleaning fluid flows through a return conduit back into the reservoir.

A cleaning device of this type is known from DE 44 02 238 A1. In this device the dry shaving apparatus is inserted with its shaving head into the receptacle. The receptacle is trough-shaped to conform to the contour of the shaving head and fully accommodates said shaving head. The receptacle has an outlet opening and an overflow which lead into a collecting container. The collecting container is connected by a return conduit to the reservoir containing the cleaning fluid. For this purpose the reservoir has a first opening into which the return conduit is inserted and sealed in place. At the beginning of the cleaning cycle the cleaning fluid is propelled by the motor-driven impelling device out of the reservoir through a second opening and by means of a conduit into the receptacle. During the cleaning cycle cleaning fluid is flushed through the receptacle continuously. This means that exactly the quantity of cleaning fluid which is conveyed into the receptacle flows back through the return conduit into the reservoir.

With the cleaning cycle beginning, cleaning fluid is conveyed out of the reservoir into the receptacle. No cleaning fluid or only a little cleaning fluid flows back into the reservoir until the receptacle is filled as far as the overflow. Hence the fluid level in the reservoir drops. This lowering of the fluid level causes the volume of air in the reservoir to increase, as a result of which the pressure in the reservoir drops. This pressure, which is lower than the atmospheric pressure, causes air to flow in through the return conduit which connects the receptacle to the reservoir. Considering that at the beginning of the cleaning cycle the cleaning fluid did not completely fill the receptacle and during the initial period of its returning to the reservoir the cross section of the return conduit was not completely closed by the returning cleaning fluid, the pressure difference between the reservoir and the surrounding atmosphere is compensated for by the influx of air through the return conduit. Air is admitted to the reservoir. After the receptacle has been filled, the quantity of cleaning fluid supplied to the receptacle flows through the return conduit into the reservoir. This leads, at the latest after the impelling device is switched off, to a rise of the fluid level in the reservoir and to a corresponding reduction of the air volume, whereupon the pressure in the reservoir increases. On account of the now lower ambient pressure the air present in the reservoir strives to escape from the reservoir. However, the returning cleaning fluid produces a fluid lock in the return conduit, thus preventing the air in the reservoir from escaping. The air is unable to overcome the resistance of the returning cleaning fluid and cannot escape from the reservoir until a sufficiently high pressure builds up in the reservoir. Deaeration of the reservoir is hence delayed. The resulting disadvantages are that the returning of the cleaning fluid is obstructed by the escaping air. These brief interruptions to the return flow of the cleaning fluid result in brief fluid pileups in the receptacle, causing the fluid stream developing in the receptacle to be disturbed. This stream is important for discharging the hair particles dislodged from the shaving head. This disturbance of the fluid stream ultimately obstructs the discharge of hair residues from the receptacle. In some cases the abrupt deaeration of the reservoir is accompanied with a noise which the user of the cleaning device might consider disturbing.

It is therefore an object of the present invention to provide a cleaning device of the type initially referred to, which enables the cleaning fluid to flow unhindered back into the reservoir. Furthermore, the fluid stream for discharging the hair residues collecting in the receptacle should not be disturbed.

This object is accomplished in accordance with the invention by providing a venting device for the reservoir. By means of this separate venting device it is possible for the air in the reservoir to escape through an outlet of its own when the internal pressure is too high, without it being disturbed by another medium. The advantage of such a cleaning device is that when the cleaning fluid flows back from the receptacle through the conduit into the reservoir it is no longer obstructed by air escaping from the reservoir and is thus able to flow continuously into the reservoir. At the same time this also prevents the brief fluid pileups in the receptacle, which are responsible for disturbing the fluid stream developing in the receptacle. Hence the cleaning device of the invention guarantees the reliable discharge of hair residues from the receptacle into the reservoir. Furthermore, the venting device enables gentler deaeration of the reservoir. The fast and abrupt escaping of air is thus prevented, ensuring that deaeration always takes place without noise. With the appropriate design the venting device can be used in addition as an aerating device.

In an advantageous aspect of the invention the venting device is comprised of a vent pipe.

To reduce the number of components the vent pipe can be combined with the return conduit to form one common component.

In a simple construction the vent pipe combines with the return conduit to form a component which is divided by a partition wall into two flow areas. The cross sections of the two flow channels can be identical. Advantageously, however, the flow channel forming the return conduit has a larger cross section than the flow channel forming the vent pipe. The cross sectional shapes of the individual conduits can take any form, e.g., semicircular, rectangular, oval.

To prevent an unintentional escaping of cleaning fluid from the reservoir, the reservoir can have an opening through which the venting device is passed and sealed by a seal.

The lower end of the vent pipe has to be arranged above the maximum fluid level in the reservoir and extend to the outside of the reservoir. The arrangement above the maximum fluid level guarantees reliable deaeration at all times. A venting device of this type is of very straightforward construction and hence characterized by low cost and ease of assembly. For the venting device to work it suffices for the vent pipe to end directly above the upper reservoir wall. With the cleaning device in an inclined position this can result in an escape of cleaning fluid through the vent pipe. In an improved aspect the upper end of the vent pipe above the reservoir is extended, whereby the extension can extend to the level of the receptacle. An extension of the vent pipe reliably prevents the unintentional escaping of cleaning fluid even when the cleaning device is inclined.

The venting device can be integrated in the reservoir containing the cleaning fluid. Renewal of the cleaning fluid at certain intervals means that the reservoir is required as a replacement part in significantly higher numbers than the cleaning device as a whole. Hence a very large number of venting devices will be needed if the venting device is integrated in the reservoir. It is an advantage therefore for the venting device to be fixed on the cleaning device.

It is particularly favorable for the venting device to be fastened, in particular by means of latching hooks, to a chassis plate carrying the chassis of the cleaning device. The venting device can be detachably connected to the chassis plate or made integrally therewith. In the case of a detachable arrangement, suitable latching points are arranged on the venting device and the chassis plate. On the venting device this can take the form of a radially circumferential collar which cooperates with the hooks, for example.

The return conduit from the receptacle into the reservoir for the cleaning fluid already provides a component on the cleaning device which is connected to the reservoir by way of an opening. Another opening in the reservoir for the venting device is avoided if the vent pipe is arranged in the opening for the return conduit. In an advantageous aspect the vent pipe is connected to the return conduit and inserted with it in a shared opening in the reservoir. The advantage of this arrangement is that there is still only one opening to be sealed against an escape of cleaning fluid. The connection of the vent pipe to the return conduit can be effected in a wide variety of ways. The vent pipe and the return conduit can be connected by positive engagement using a latch or clip connection or by material engagement. Connecting the two pipes by means of bars may also be contemplated. In another aspect the two conduits form a common component with a partition wall for division into two flow channels.

In yet another aspect at least a part of the wall of the venting device extends to the bottom of the reservoir. In this case it is possible for a part of the wall of the venting device or a part of the return conduit to be constructed such that a fluid stream conducive to the sedimentation of dirt particles forms in the cleaning fluid flowing back through the return conduit. For this purpose a part of the wall of the venting device can be constructed such that the cleaning fluid can be deflected at an angle, preferably approximately parallel to the bottom of the reservoir, when it leaves the return conduit. Cleaning fluid which impacts vertically on the reservoir bottom can cause turbulence that swirls up any dirt particles which have already settled on the bottom. Through the deflection caused by the wall the cleaning fluid flows parallel, or at a slight angle, to the bottom of the reservoir. A fluid stream thus develops which favors the deposition of those hair residues which were entrained with the cleaning fluid out of the receptacle. The wall section which deflects the cleaning fluid can also be a part of the wall of the return conduit. Deflection of the inflowing cleaning fluid in a direction away from the suction line has proven to be advantageous in effecting the greatest possible deposition of dirt particles and hence keeping the number of particles in the circulated cleaning fluid low.

In another aspect, the cleaning device of the invention is particularly economical when the venting device is a venting bore with a small cross section, preferably with a diameter of around 1 mm to 2 mm, in particular 1.5 mm. A venting bore of this type can be arranged, for example, in the seal for the opening through which the return conduit enters the reservoir or in the reservoir wall. An escape of cleaning fluid is reliably prevented when the diameter of the bore is chosen such that air is allowed to escape but the cleaning fluid is no longer able to on account of its surface tension. Another possibility is for the venting bore to be covered by an air-permeable and liquid-impermeable membrane.

In another aspect the venting device can be constructed as a valve. Valves with a diaphragm as closing element have proven to be particularly favorable as a very low opening pressure of the valve can be set with a diaphragm. Furthermore, the diaphragm has the advantage of closing the opening during the period when no cleaning of the shaving head is being performed. This hinders the evaporation of the cleaning fluid, which contains volatile constituents.

Further objects, features, advantages and application possibilities of the present invention will become apparent from the subsequent description of the embodiments. It will be understood that any single feature or any combination of single features described or represented by illustration form the subject-matter of the present invention, irrespective of their summary in the claims or their back-references.

Embodiments of the present invention are illustrated in the drawing and will be described in greater detail in the following. In the drawing,

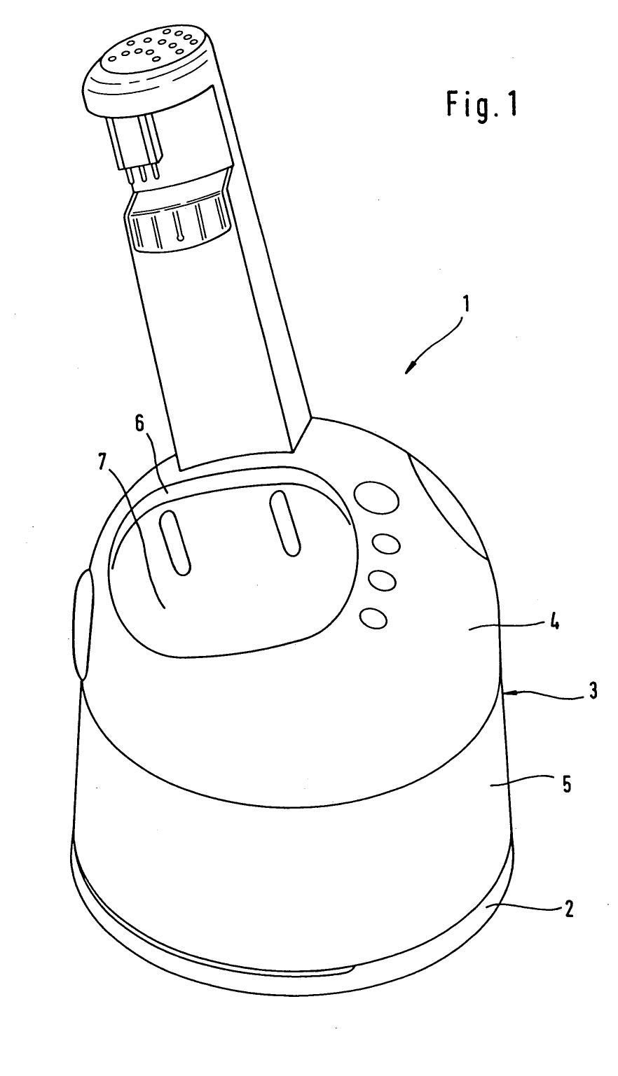

FIG. 1 is a view of a cleaning device;

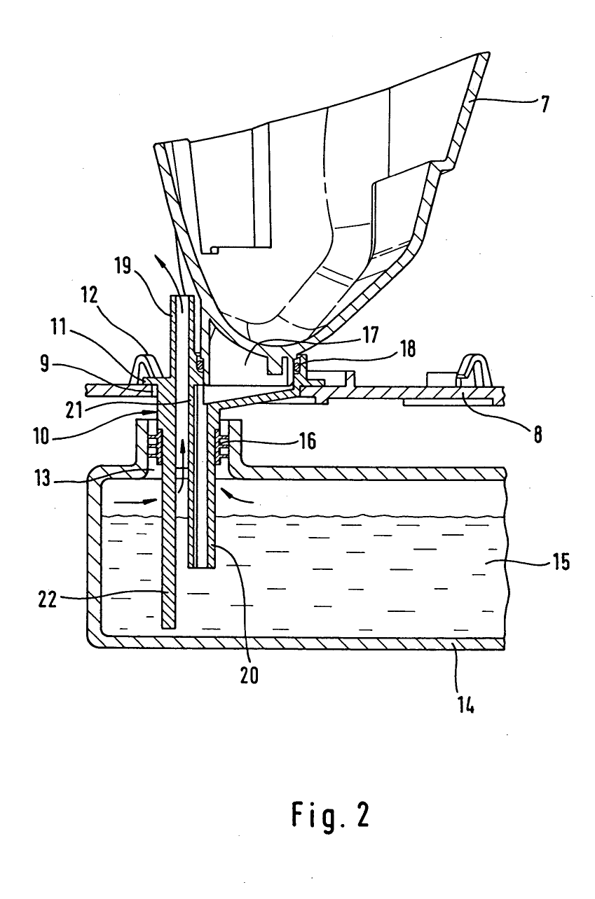

FIG. 2 is a sectional view of a receptacle and a venting device;

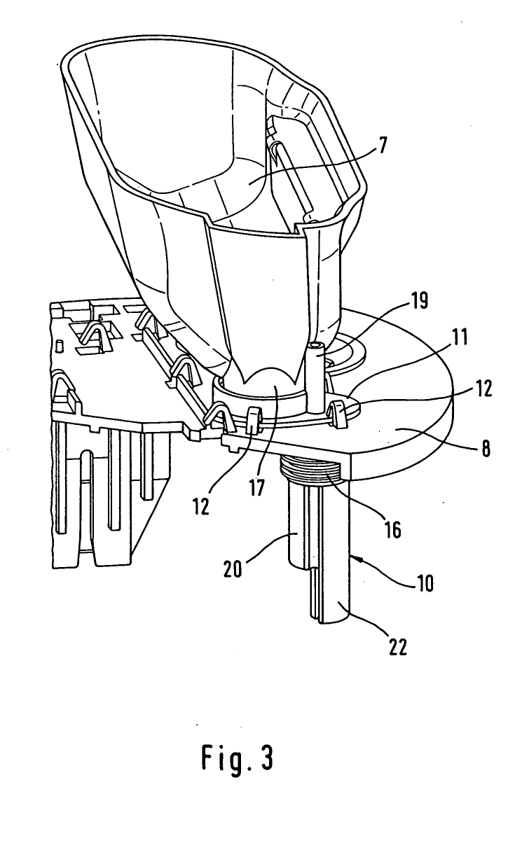

FIG. 3 is a perspective view of the receptacle with the venting device of FIG. 2; and

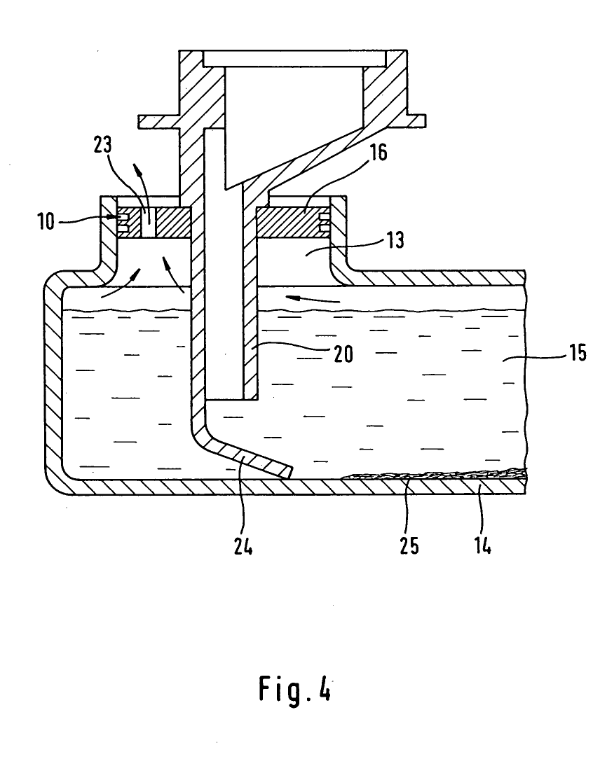

FIG. 4 is a view of a second embodiment of a venting device.

The cleaning device 1 shown in FIG. 1 is comprised of a bottom plate 2 and a chassis 3. The chassis 3 is composed of two housing parts 4, 5. For cleaning, the shaving head of a dry shaving apparatus, not shown, is inserted into a receptacle 7 through an opening 6 in the housing part 4. Arranged underneath the chassis 3 are the devices needed for cleaning the dry shaving apparatus such as the reservoir and the impelling device for the cleaning fluid.

The receptacle 7 shown in FIG. 2 is arranged above a chassis plate 8 carrying the chassis 3. A venting device 10 is inserted in an opening 9 of the chassis plate 8. The venting device 10 has a collar 11 with which the venting device 10 sits on the opening 9. The venting device 10 is fastened through its collar 11 to the chassis plate 8 by means of hooks 12 arranged on the chassis plate 8. The venting device 10 is inserted in an opening 13 of a reservoir 14 containing the cleaning fluid 15.

A lip seal 16 seals the venting device 10 against the opening 13. The receptacle 7 has in its lower region an opening 17 into which the venting device 10 is inserted. An O-ring 18 seals this connection.

The venting device 10 comprises a vent pipe 19, which starting from above the maximum fluid level in the reservoir 14 extends up to the level of the receptacle 7. The arrangement of the vent pipe 19 above the maximum fluid level guarantees sufficient venting of the reservoir 14 at all times. The outflowing air is indicated with arrows. Thanks to the length of the vent pipe 19, it is impossible for cleaning fluid 15 to escape through the vent pipe 19, even with the cleaning device 1 at a significant incline. Together with a return conduit 20 the vent pipe 19 forms a single component with a shared partition wall 21.

The cleaning fluid 15 conveyed into the receptacle 7 in order to clean the shaving head can flow through the return conduit 10 back into the reservoir 14. A part of the wall 22 of the venting device 10 is extended in downward direction.

FIG. 3 shows the arrangement of the receptacle 7 above the chassis plate 8. In the area of the opening 17 the receptacle 7 is inserted in the venting device 10. By means of the hooks 12 the venting device 10 is fastened to the chassis plate 8 through its collar 11. The venting device 10 is sealed against the reservoir, not shown in this Figure, by means of the lip seal 16. The vent pipe 19 is arranged on the side adjacent to the receptacle 7.

In another embodiment according to FIG. 4 the venting device 10 is a venting bore 23. The venting bore 23 has a diameter of 1.5 mm and is arranged in the seal 16 with which the return conduit 20 is sealed against the opening 13 of the reservoir 14. A part 24 of the wall of the return conduit 20 has its lower end bent. The returning cleaning fluid 15 is thus deflected sideways, promoting the deposition of hair residues 25.

1-14. (cancelled)

15. A cleaning device for a shaving head of a dry shaving apparatus, the device comprising:
a reservoir to store a cleaning fluid;
a receptacle adapted to receive the shaving head and the cleaning fluid, the receptacle being configured to direct the cleaning fluid toward the shaving head;
a return conduit extending from the receptacle to the reservoir to convey the cleaning fluid from the receptacle into reservoir; and
a venting device attached to the reservoir.

16. The cleaning device of claim 15 wherein the venting device comprises a vent pipe.

17. The cleaning device of claim 16 wherein the vent pipe and the return conduit are integrally formed into a venting assembly.

18. The cleaning device of claim 16 wherein a lower end of the vent pipe is disposed above a maximum fluid level in the reservoir.

19. The cleaning device of claim 16 wherein an upper end of the vent pipe extends beyond a portion of the receptacle.

20. The cleaning device of claim 17 wherein venting assembly comprises a partition wall substantially dividing the assembly into first and second flow regions.

21. The cleaning device of claim 20 wherein at least a portion of the wall extends to a bottom surface of the reservoir.

22. The cleaning device of claim 15 wherein the reservoir comprises:
an opening for receiving the venting device; and
a seal for substantially sealing the venting device to the reservoir.

23. The cleaning device of claim 15, further comprising a chassis plate, the venting device being attached to the chassis plate.

24. The cleaning device of claim 23, wherein the venting device further comprises latching points to attach the venting device to the chassis plate.

25. The cleaning device of claim 24 wherein the latching points comprise a radially protruding, circumferential collar.

26. The cleaning of claim 25 wherein the portion of the wall is configured to develop a fluid flow pattern in a return flow of the cleaning fluid back through the return conduit conducive to the deposition of dirt particles.

27. The cleaning device of claim 25 wherein a guide extending from the return conduit is configured to develop a fluid flow pattern in a return flow of the cleaning fluid back through the return conduit conducive to the deposition of dirt particles.

28. The cleaning device of claim 25 wherein the portion of the wall deflects at an angle from the vertical.

29. The cleaning device of claim 28 wherein the portion of the wall is substantially parallel to the bottom of the reservoir.

30. The cleaning device of claim 15 wherein the venting device (10) comprising a venting bore.

31. The cleaning device of claim 15 wherein the venting bore has a cross-sectional diameter between about 1 mm to about 2 mm.

32. The cleaning device as claimed in claim 15 wherein the venting device comprises a valve.

33. The cleaning device of claim 32 wherein the valve comprises a diaphragm as a closing element.

34. A cleaning device for a shaving head of a dry shaving apparatus, the device comprising:
a reservoir for storing a cleaning fluid;
a receptacle adapted to receive the shaving head and the cleaning fluid, the receptacle being configured to direct the cleaning fluid toward the shaving head;
a return conduit extending from the receptacle to the reservoir to convey the cleaning fluid from the receptacle into reservoir; and
a vent pipe substantially adjacent the return conduit, the vent pipe being attached to the reservoir.

35. A shaving system comprising:
the cleaning device of claim 15; and
a dry shaving apparatus adapted and configured for use with the cleaning device.

36. A method of cleaning the shaving head of a dry shaving apparatus, the method comprising:
inserting the shaving head into a receptacle;
flowing cleaning fluid into the receptacle and toward the shaving head from a storage reservoir; and
continuously flowing cleaning fluid from the receptacle into a the storage reservoir, while venting the reservoir to the atmosphere.

37. The method of claim 36, further comprising depositing residue from the cleaning fluid substantially uniformly along a bottom surface of the reservoir.
